(19) United States
(12) Patent Application Publication
(10) Pub. No.: US 2004/0122897 A1
(43) Pub. Date: Jun. 24, 2004

(54) Adapting a document repository to support fine-grained change requests, lightweight transactions and asynchronous notifications

(75) Inventors: Alexander D. Seelemann II, Thornhill (CA); Niall Ian Clifford, Southampton (GB); John F. Hibbert, Winchester (GB); Matthew P. Lucas, Southampton (GB)

Correspondence Address: Leslie A. Van Leeuwen, International Business Machines Corporation, Intellectual Property Law Department, 11400 Burnet Road, Austin, TX, 78758, US

(73) Assignee: INTERNATIONAL BUSINESS MACHINES CORPORATION, ARMONK, NY

(21) Appl. No.: 10/682,398

(22) Filed: Oct. 9, 2003

(30) Foreign Application Priority Data
Dec. 20, 2002 (CA) 2,414,952

(51) Int. Cl. G06F 15/16; G06F 17/30; G06F 7/00

(52) U.S. Cl. 709/204; 707/9; 715/511

(57) ABSTRACT

A repository adapter, repository adapter client and methods provide enhanced collaborative authoring of documents stored on a repository. Repository adapter clients access the repository using the repository adapter that is adapted to communicate with the clients using a bi-directional asynchronous protocol. The repository adapter communicates with the repository in accordance with a repository protocol such as the WebDAV protocol. The repository adapter performs change requests on behalf of clients in a transactional manner, in communication with the repository. Serialization of requests by clients and transactional processing by the shared repository adapter serves to reduce resource contention otherwise experienced by collaborative authors in a conventional WebDAV environment. Fine grain changes to objects, relationships and attributes may be made using the repository adapter. Further the repository adapter asynchronously updates clients when the document model is changed, freeing the collaborative author from determining whether documents must be refreshed and obviating pre-emptive locks.

### TECHNICAL FIELD

The present invention relates to the field of collaborative data processing by a plurality of clients having access to documents over a network, and more particularly to a system which uses an adapter server between a document repository and those clients.

### BACKGROUND OF THE INVENTION

Systems which allow users to collaboratively edit and manage documents on a remote server are widely used in the data processing industry to support remote software development teams and virtual enterprises. These systems provide important features such as versioning, parallel development, and configuration management, for the purpose of remote authoring of documents for storing in a repository.

Many of these collaborative authoring and versioning systems operate using the Web-based Distributed Authoring and Versioning (WebDAV or DAV) protocol. WebDAV extends the hyper-text transfer protocol (HTTP) to provide remote access to documents and standardized command support including lock, check-out, check-in and versioning. Major features of the protocol include locking for concurrency control, properties for associating with resources and namespace manipulation operations. WebDAV supports long-duration exclusive and shared write locks that prevent an overwrite problem, for example, where two or more collaborators write to the same resource (e.g. document) without first merging their respective changes. The duration of WebDAV locks is independent of any individual network connection to achieve robust Internet-scale collaboration and scalability. Extensible Markup Language (XML) properties provide storage for arbitrary meta-data for resources, such as a list of authors. As a collaboratively authored web site evolves, for example, resources may need to be copied or moved and WebDAV supports such operations. Collections, similar to file system directories, may be created and listed.

WebDAV operates at the document level. When making a change, a user must obtain exclusive rights to the entire document (i.e. a lock) and preferably to all other documents that may be impacted by the change in the locked document. The requirement to lock a document creates resource competition among users and makes a collaborative system less efficient, because users need to preemptively lock documents which they may need to update later. In accordance with WebDAV, such locks persist until explicitly released by a user interaction. WebDAV may be better understood with reference to the Internet Engineering Task Force (IETF) document entitled, “HTTP Extensions for Distributed Authoring—WebDAV” RFC 2518 dated February 1999, the contents of which are incorporated herein by reference. Other collaborative authoring and versioning systems include Concurrent Versioning System (CVS™) an open-source version control system (http://www.cvshome.org/) and Rational™ ClearCase™ of Rational Software Corporation.

One software engineering technique that is often used in developing web applications in accordance with object oriented principles is the Model-View-Controller (MVC) paradigm for development tool graphic user interfaces (GUIs). MVC is a technique for breaking down an application into three components, namely, the model, view and controller. A model represents, for example, enterprise data and the business rules that delineate dealings with the data (e.g. access and updates). Conveniently, the model often serves as an approximation of a real-world process or system. The view provides a means to render the contents of the model for display to a developer. When a model changes, the view should automatically redraw the affected part of the display to update the change. The means by which a developer interacts with the application is the controller. The controller handles user input, instructing the model and view, as applicable, to perform actions in response to the input. Development tools which permit a model based representation are often preferred, particularly in a collaborative development environment.

Yet, another disadvantage of the existing WebDAV protocol is a lack of notification to each user about changes in documents or changes in the model defined by portions of the documents. As the WebDAV protocol is an HTTP extension, it is both synchronous and a client-driven or “pull” protocol of request and response that is not designed for pushing information such as a notice of a change in the data model to users. As a result, when one collaborative author updates a document and checks it in to the repository, other collaborative authors will not be advised of the change and may thus need to regularly request information from the repository including an updated data model.

A WebDAV repository may be useful in an operational as well as a developmental environment, particularly where there is a need for collaborative authoring of documents for an application in operation. WebSphere MQ Event Broker and WebSphere® MQ Integrator Broker (WMQI Broker) from International Business Machines Corporation individually are an effective means of bringing together information from disparate applications without modifying the applications. Messages flow point to point or between publishers and subscribers asynchronously via message queues in accordance with a publish/subscribe paradigm brokered by message brokers. One key component of WMQI is a Configuration Manager including a WebDAV repository to control configuration data about a broker and its peers. The configuration manager stores configuration data for a complete WMQI Broker domain, including message brokers, publish/subscribe message systems, message repository model (MRM), operational status or information and event logs. The configuration data is partitioned across many different documents, each with different content types. In order to support a complex application document model, XLink/XPointer standard hypertext link references are embedded in each document. These references indicate objects in other documents to form a rich application model.

The configuration manager uses WebDAV locks to provide mutual exclusion and access control on a per-document basis. The configuration information, meaning the “live” data that controls the configuration manager such as topic access controls, as opposed to WMQI application meta-data, such as program source code, tends to be updated in short sessions using locks that are immediately unlocked. In practice, modified data is usually of finer granularity than a complete document, for example a change in hypertext references for referential integrity or a change to an attribute. Multiple users are frequently likely to update a small part of the same object in a document or make compatible changes. Therefore, the per-document granularity of the WebDAV lock model is too coarse and frequently causes lock contention.

The configuration manager's use of per-document locks also causes problems involving transactions across multiple objects and change interleaving. The WebDAV protocol does not provide a mechanism for associating a sequence of document check-in actions together as a transaction. This means the relational integrity of the model can be compromised if some, but not all, of the documents are successfully checked-in to the repository. The client cannot undo the successful check-ins if some were unsuccessful.

This problem may be illustrated by a simple example where two documents are associated in a parent-child relationship by respective hypertext references (“href”) in a tree-like hierarchy and a user desires to associate the child document to a different parent. For example, to implement the desired change by a drag and drop operation in a graphical user interface view of the documents, the original parent document needs to have the “href” reference to the child removed, the new parent document needs to have an “href” reference to the child added, and the child needs to have its parent “href” reference updated. Three documents must be amended and checked in to the repository. If only the first removal succeeds, then the child cannot be reached from either parent. If only the add operation succeeds, then the child is left with two parents. This lack of transactionality makes implementing robust drag and drop impossible without extra “global” locks, which would cause further lock contention.

Change interleaving is the result of multiple users making contradictory changes and is also related to the problem of transactions. If a user (Alice) locks two documents A and B, updates both, and checks in A, another user (Bob) can lock A, make a change that is incompatible with Alice's change in B, and check the new version of A into WebDAV. Neither user will become aware of the incompatibility until after Alice checks in B and either developer refreshes both A and B. Implementing the change as a transaction would require Alice to check-in her changes to A and B without interruption, thus preventing Bob from interleaving his change into A.

Given the document granularity of changes in WebDAV, multiple documents may need to be locked to perform a consistent update in the repository. Each user must obtain exclusive rights to all documents that their changes may impact. This also results in lock contention, because multiple users need to lock the same documents to maintain the application information model's referential integrity, rather than just updating the model fragments.

Since WebDAV is a “pull” protocol, it is not possible for the configuration manager to asynchronously inform its clients that the model is changed and they need to obtain fresh data. A result is that users preemptively lock resources which they may need to update later. This again results in resource contention when other users need to create locks for the same reason. Alternatively, useful functions (such as drag and drop behaviours) cannot always be implemented because resource contentions cannot always be identified in advance.

Users also dislike the check-out/check-in process. Referential integrity checks frequently interrupt their work when a task cannot be completed due to a missing but required lock. Failing to check-in a locked resource can result in model integrity errors in the configuration manager that are hard to diagnose. The sheer number of locks and documents to manage seemingly small changes can make tasks difficult and slow.

A common solution to the problem of change interleaving is for WebDAV clients to implement an “optimistic locking” paradigm. In this solution, a WebDAV client creates its locks before checking the results in, and then attempts to compute differences between the original client version, the current client version, and the current repository version. An automatic 3-way compare is performed and the results are merged by the client and checked in. The difficulty of providing automatic 3-way merge means the user must be involved in managing the merge.

Therefore, there is a need for a system and method for collaboration that enables fine-grained modification requests, lightweight transactions, and client notifications of changes. Also there is a need for a system that eliminates the necessity for clients to manage locks on the WebDAV repository.

### SUMMARY OF THE INVENTION

The present invention is directed to adapting a document repository to support fine-grained change requests, lightweight transactions and asynchronous notifications. In one aspect of the invention there is provided a repository adapter for facilitating the collaborative authoring by a plurality of clients of documents for storage in a repository. The repository adapter comprises a controller for processing and responding to client requests for authoring the documents where the processing is performed in a transactional manner. The repository adapter communicates with the clients to receive client requests and to send client responses to said requests and communicates the repository to send repository requests for authoring the documents and to receive repository responses for processing the client requests.

Typically, the documents define a document model and the controller is adapted to maintain a repository adapter document model subset from documents processed in accordance with the client requests. As such, the repository adapter can serve clients from the subset and selectively communicate with the repository.

Preferably, the controller is adapted to asynchronously communicate a document model update for updating a respective client document model subset maintained by each of the plurality of clients. Advantageously, the changes to one or more documents made by a client can be communicated to all clients, without the need for the clients to periodically check for updates.

The client requests preferably comprise serialized updates to the repository adapter document model to affect changes to selected documents for storage to the repository. The serialized updates facilitated enhanced transactional processing of changes made by a collaborative author.

The repository adapter may be a WebDAV repository.

In accordance with a further aspect of the invention, there is provided a repository adapter client for facilitating the collaborative authoring by a plurality of clients of documents for storage in a repository. The repository adapter client comprises a controller for creating client requests for authoring said documents and is adapted to communicate the client requests to a repository adapter and to receive client responses to the requests. The repository adapter processes the client requests in a transactional manner and, selectively, in communication with the repository.

The repository adapter client is preferably adapted to maintain a client document model subset from documents processed in accordance with said client requests. Further, the repository adapter client may be adapted to asynchronously receive a document model update identifying changes for updating the client document model subset.

In an embodiment the repository adapter client generates client requests that each comprise serialized updates to the client document model to affect changes to selected documents for storage to the repository.

The repository adapter client may adapt an integrated development environment (IDE) for collaboratively authoring the documents in communication with the repository adapter.

In a further aspect, a method for collaboratively authoring documents for storage to a document repository is provided. The method comprises steps of maintaining a document model subset defined by at least a subset of the documents stored to the repository; receiving from a client a client request for collaboratively authoring said documents; processing the client request in a transactional manner and, selectively, in communication with the repository; and sending a notification message to the client in response to a success of the processing of the client request. The method may also comprise sending asynchronously a document model update message to each of a plurality of clients for updating a client document model subset respectively maintained by the clients upon a successful processing of the client request.

Preferably, the client request comprises serialized updates to the document model subset to affect changes to selected documents for storage to the repository.

In accordance with another aspect of the invention, there is a method for collaboratively authoring documents for storage to a document repository comprising steps of maintaining a document model subset defined by at least a subset of the documents stored to the repository; sending to a repository adapter a client request for collaboratively authoring the documents, the repository adapter adapted for processing the request message in a transactional manner and, selectively, in communication with the repository; and receiving a notification message from the repository adapter in response to a success of the processing of the client request.

A further aspect of the invention provides an integrated development environment (IDE) for collaboratively authoring documents for storage to a repository. The IDE comprises a graphical user interface for facilitating the authoring of a document model subset defined by at least a subset of documents stored to said repository; a mechanism for serializing updates to the document model subset in response to the authoring; and a communications interface to send client requests comprising the serialized updates to a repository adapter adapted for processing client request messages in a transactional manner and, selectively, in communication with the repository.

Finally, the invention also provides a method of adapting a WebDAV repository to asynchronously notify a plurality of clients of a change to at least one document stored to the WebDAV repository. This method comprises maintaining a document model subset defined by at least a subset of documents stored to the WebDAV repository; receiving from a client a client request for collaboratively authoring at least one of said documents; processing the client request in communication with the WebDAV repository; and sending asynchronously a document model update message to the plurality of clients to notify the clients of the change to the at least one of said documents. The method preferably involves processing the client request in a transactional manner.

### BRIEF DESCRIPTION OF THE DRAWINGS

Further features and advantages of the present invention will become apparent from the following detailed description, taken in combination with the appended drawings, in which:

FIG. 1 is a schematic block diagram illustrating a system for collaboratively authoring documents for storage to a WebDAV repository by remote clients;

FIG. 2 is a schematic block diagram in accordance with the invention further illustrating a portion of the system of FIG. 1;

FIG. 3 illustrates, in functional block form, a portion of the memory of FIG. 2;

FIG. 4 is a schematic block diagram in accordance with the invention further illustrating a portion of memory for the repository adapter server of FIG. 1;

FIG. 5 is a topics hierarchy model in a model language form;

FIG. 6 illustrates in graphical form a topic hierarchy instance; and

FIG. 7 is a flow chart illustrating steps of a method of operating the system of FIG. 1 in accordance with the invention.

It should be noted that throughout the appended drawings, like features are identified by like reference numerals.

### DETAILED DESCRIPTION OF THE PREFERRED EMBODIMENT

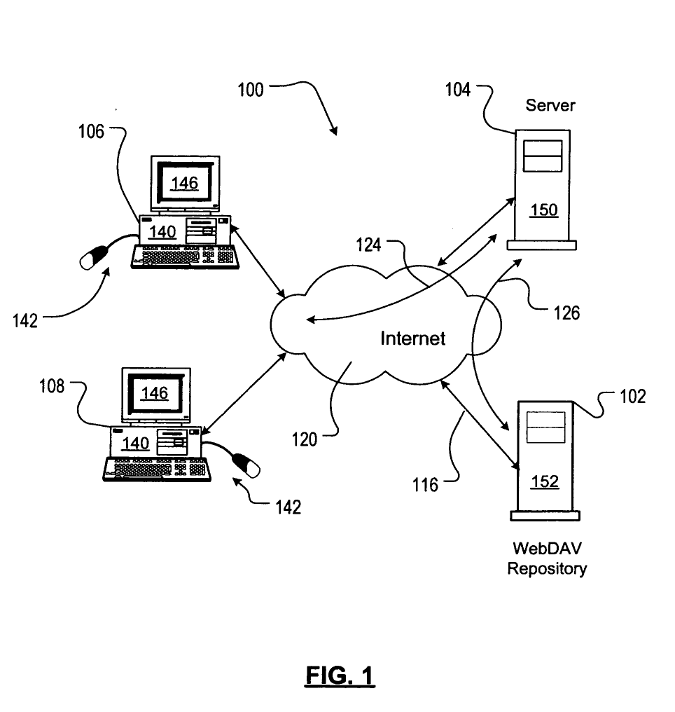

FIG. 1 is a schematic block diagram illustrating a system for collaboratively authoring documents stored on a WebDAV repository by remote clients. The illustrated system 100 comprises a WebDAV repository 102, a repository adapter server 104 and client computing devices 106 and 108 (only two of a possible greater plurality of computing devices is shown).

Client computing devices 106 and 108 can access WebDAV repository 102 over a network 120 such as the Internet using server 104. Though the Internet is illustrated as an embodiment of network 120, other or additional networks or communication connections may be used as is well known to persons skilled in the art, including: local area networks, wide area networks, intranets, and the like.

WebDAV repository 102 is used to store and perform repository functions such as configuration management and versioning of various documents under collaboration by users of client computing devices 106 and 108. Documents under collaboration typically comprise documents such as HTML or XML documents and may include other source code documents, graphics, sound, CGI, text and others. By way of example, WMQI applications are typically developed in accordance with MVC principles. Thus, configuration management typically comprises reviewing and editing documents representing the model. Such documents are typically collaboratively authored using an IDE comprising various tools and an MVC-based GUI as discussed further below.

Throughout the description herein, aspects of the invention are illustrated as being embodied solely on particular computing devices of computer system 100. As will be appreciated by those of ordinary skill in the art, aspects of the invention may be distributed amongst one or more networked computing devices which interact with computer system 100 via one or more data networks such as, for example, network 120. However, for ease of understanding, aspects of the invention have been embodied in particular single computing devices such as client devices 106 and 108, repository adapter server 104 and WebDAV repository 102.

Client computing devices 106 and 108 each typically include a processing system 140 which communicates with various input devices 142, output devices 146 and network 120. Input devices 142, two of which are shown, may include, for example, a keyboard, a mouse, a scanner, an imaging system (e.g., a camera, etc.) or the like. Similarly, output devices 146 (only one of which is illustrated) may include displays, printers and the like. Additionally, combination input/output (I/O) devices may also be in communication with processing system 140. Examples of conventional I/O devices include removable and fixed recordable media (e.g., floppy disk drives, tape drives, CD-ROM drives, DVD-RW drives, etc.), touch screen displays and the like.

Repository adapter server 104 and WebDAV repository server 102 may be similarly configured to include a processing system 150, 152 which communicates with network 120. Optionally, though not shown, processing system 150, 152 may communicate with input devices and output devices as previously described with reference to client devices 106, 108. Additionally, combination input/output (I/O) devices may also be in communication with processing system 150, 152 as is well understood by persons of ordinary skill in the art.

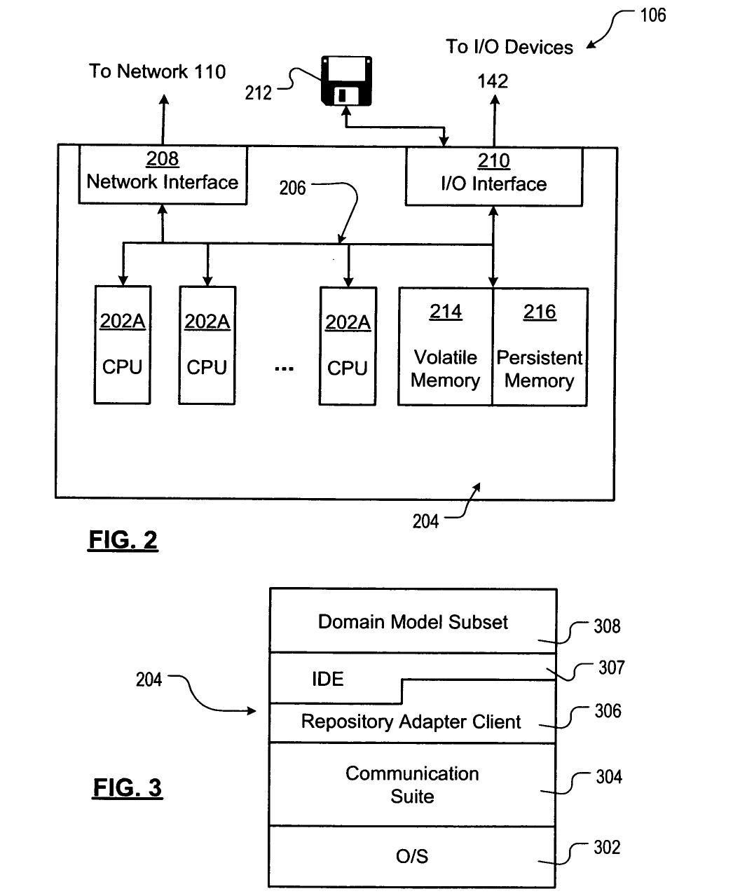

Exemplary client processing system 140 is illustrated in greater detail in FIG. 2. As illustrated, processing system 140 includes several components—central processing unit (CPU) 202, memory 204, network interface (I/F) 208 and I/O I/F 210. Communication between various components may be facilitated via a suitable communications bus 206 as required.

CPU 202 is a processing unit, such as an Intel Pentium™, IBM PowerPC™, Sun Microsystems UltraSparc™ processor or the like, suitable for the operations described herein. As will be appreciated by those of ordinary skill in the art, other embodiments of processing system 140 could use alternative CPUs and may include embodiments in which one or more CPUs are employed. CPU 202 may include various support circuits to enable communication between itself and the other components of processing system 140.

Memory 204 includes both volatile memory 214 and persistent memory 216 for the storage of: operational instructions for execution by CPU 202, data registers, application storage and the like. Memory 204 preferably includes a combination of random access memory (RAM), read only memory (ROM) and persistent memory such as that provided by a hard disk drive.

Network I/F 208 enables communication between client computing device 106, 108 and other network computing devices (e.g. server 104) via network 120. Network I/F 208 may be embodied in one or more conventional communication devices. Examples of a conventional communication device include an Ethernet card, a token ring card, a modem or the like. Network I/F 208 may also enable the retrieval or transmission of instructions for execution by CPU 202 from or to a remote storage media or device via network 120.

I/O I/F 210 enables communication between processing system 140 and the various I/O devices 104 and 106. I/O I/F 210 may include, for example, a video card for interfacing with an external display such as output device 106. Additionally, I/O I/F 210 may enable communication between processing system 140 and a removable media 212. Removable media 212 may comprise a conventional diskette or other removable memory devices such as Zip™ drives, flash cards, CD-ROMs, static memory devices and the like may also be employed. Removable media 212 may be used to provide instructions for execution by CPU 202 or as a removable data storage device.

Though not shown, repository adapter server 104 may be similarly configured from several components suitable for a server as is illustrated for exemplary client computing devices 106 and 108 and as is well understood to persons having ordinary skill in the art. Similarly, WebDAV repository server 102 may also be so configured.

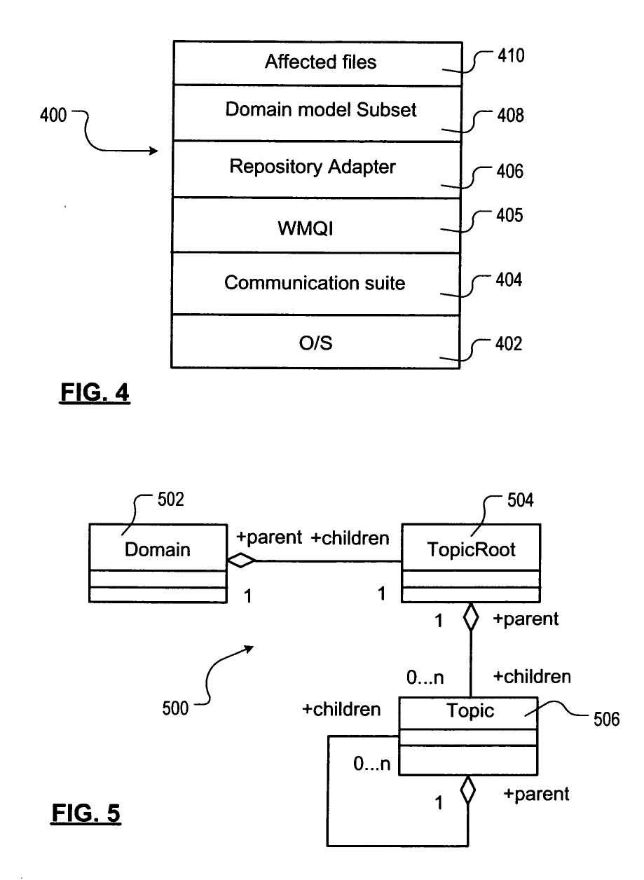

The computer instructions/applications stored in memory 204 and executed by CPU 202 (thus adapting the operation of client computing devices 106 and 108 as described herein) are illustrated in functional block form in FIG. 3. The computer instructions/applications stored in a memory 400 and executed by a CPU (not shown) of server processing system 150 (thus adapting the operation of repository adapter server 104 as described herein) are illustrated in functional block form in FIG. 4. As will be appreciated by those of ordinary skill in the art, the delineation between aspects of the applications illustrated as functional blocks in FIG. 3 and respectively, FIG. 4 is somewhat arbitrary as the various operations attributed to a particular application as described herein may, in alternative embodiments, be subsumed by another application. WebDAV repository server system 152 may be configured in accordance with conventional applications providing WebDAV functionality and need not be adapted for the purposes of the present invention.

With reference to FIG. 3., for exemplary purposes only, memory 204 stores operating system (OS) 302, communications suite 304, Integrated Development Environment (IDE) 305, repository adapter client 306, and document model subset 308.

OS 302 is an operating system suitable for operation with a selected CPU 202 and the operations described herein. Multitasking, multithreaded OSes such as, for example, IBM AIX™, Microsoft Windows NT™, Linux or the like, are expected in many embodiments to be preferred.

Communication suite 304 provides, through, interaction with OS 302 and network I/F 208 (FIG. 2), suitable communication protocols to enable communication with other networked computing devices via network 120 (FIG. 1). Communication suite 304 may include one or more of such protocols such as TCP/IP, Ethernet, token ring and the like. Communications suite preferably includes asynchronous transport communication capabilities for communicating with server 104 for the purposes of collaborative authoring to avoid limitations of synchronous communications, such as waiting for a reply. Published UK Patent Application GB 2 351 573 A, dated Jan. 1, 2001 discloses using WebDAV with an asynchronous transport the contents of which are incorporated herein.

Also stored in memory 204 (and used during the collaborative authoring process) and incorporating aspects of the present invention is an IDE 305 including a repository adapter client 306. In the exemplary embodiment, IDE 305 configured with repository adapter client 306 provides a collaborative user (or a team of such users) a collaborative development environment using a graphical user interface (GUI) known to those skilled in the art. The GUI typically includes a number of windows or panes for authoring documents, including viewing, editing, creating and managing documents, project documents, properties and attributes, debugging information or the like which documents and, preferably, associated meta-data may be stored in a document repository.

The Eclipse Project, comprising open source software from the eclipse.org consortium (http://www.eclipse.org), is a platform providing an open, extensible IDE for the development and integration of tools for application developers. Such tools assist a developer with, among other things, editing, configuring, implementing, testing and debugging applications. Eclipse supports and has available visual development tools in accordance with the MVC paradigm and may be useful as IDE 305 and be adapted in accordance with the present invention with resource adapter client 306.

Unlike conventional IDEs configured for use with a WebDAV repository, repository adapter client 306 adapts such an IDE to communicate with a repository adapter 406 (FIG. 4) at server 104 in accordance with the invention. Through communication with repository adapter 406, client 306 is able to assist collaborators to author documents for storage in WebDAV repository 102. A subset of the documents authored by repository adapter client 306 for storage in repository 102 define the document model subset 308 stored in memory 204.

The operation of repository adapter client 306 and its interaction with the repository adapter 406 and document model subset 308 is better understood with reference to FIGS. 5 to 7 described below.

As illustrated in FIG. 4., for exemplary purposes only, memory 400 of server 104 stores operating system (OS) 402, communications suite 404, WMQI Broker and configuration manager 405, repository adapter 406, document model subset 408 and affected documents 410.

OS 402 is an operating system suitable for operation with a selected CPU (not shown) for a server and the operations described herein. Expected in many embodiments to be preferred are multitasking, multithreaded OSes. Exemplary OSes suitable for WMQI Broker and Configuration Manager include, IBM® AIX®, Microsoft Windows 2000™, Windows NT®, z/OS™, SUN® SOLARIS® and HP-UX®.

Communications suite 404 provides, through interaction with OS 402 and a network I/F for server 104 (not shown), suitable communication protocols to enable communication with other networked computing devices via network 120 (FIG. 1). Communication suite 404 may include one or more of such protocols such as TCP/IP, Ethernet, token ring and the like as previously discussed. Communication suite 404 may include any necessary components for facilitating communications between WMQI configuration manager 405 and resource adapter client 306 such as WebSphere MQ Series™ of IBM Corporation.

In the exemplary embodiment, repository adapter 406 facilitates communication from clients at 106 & 08 with WMQI Configuration Manager 405. The WebDAV repository 102 functionality is included in the WMQI Configuration Manager 405 though for purposes of illustration is shown separately.

Stored in memory 404 for use during the collaborative authoring process in accordance with aspects of the present invention is repository adapter 406 for facilitating communications with WebDAV repository 102. Repository adapter 406 is configured in accordance with the invention to communicate with client computing devices 106 and 108 over network 120 using a bi-directional protocol that is schematically illustrated (FIG. 1) by a double arrowed curve 124 and to communicate with WebDAV repository 102 using the WebDAV protocol as schematically illustrated by a double arrowed curve 126. The use of the bi-directional protocol 124 enables bi-directional interaction between the client computing devices 106 and 108 and the server 104 and implements fine-grained changes to the documents, including particularly, changes to document relationships and attributes. Repository adapter 406 solves resource contention problems by eliminating the need for clients to manage locks on WebDAV repository 102. As described further below, repository adapter 404 on server 104 serializes resource requests, holding locks only as long as they are needed.

The collected subsets of the documents authored by all resource adapter clients 306 of system 100 define the document model subset 408 stored in memory 400 as described further below. Selected documents which collaborative users have requested changes are copied by resource adapter 406 and define the affected documents 410 stored in memory 400 as described in detail hereinafter.

By way of example, configuration documents for a WMQI-based application are described to illustrate a type of document which may be collaboratively authored in accordance with the invention. FIG. 5 illustrates a topics hierarchy model 500 in Unified Modeling Language™ (UML™) (Trademark of Object Management Group) for messages in a publish/subscribe messaging environment such as MQ.

A root object 502 of the WMQI model is the “Domain”. “Domain” aggregates object 504, the “TopicRoot” object, meaning if Domain were deleted, TopicRoot would also be deleted. Domain object 502 and TopicRoot object 504 are connected by a bidirectional relationship. Domain may contain at most one TopicRoot, and TopicRoot can reference at most one Domain.

TopicRoot object 504 aggregates zero or more “Topic” objects 506, also through a parent/child relationship. And each “Topic” aggregates zero or more “Topic” objects 506 through a parent/child relationship.

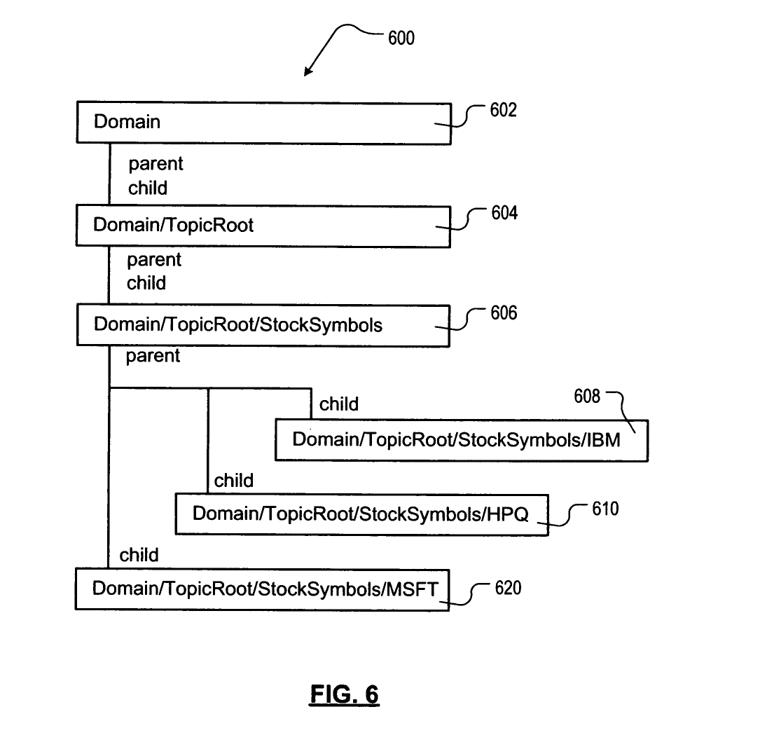

The following XML document fragments describe a topic hierarchy, starting at the domain, for a model instance illustrated in graphical form in FIG. 6.

WebDAV document named “Domain”
+-----------------------------------------------------+

<Object type=“Domain”>

<Property name=“name”>Domain</Property>
<Relationship name=“parent” cardinality=“0..1”/>
<Relationship name =“children” cardinality=“0..n”>

<Reference>Domain/TopicRoot</Reference>

</Relationship>

</Object>

+-----------------------------------------------------+
WebDAV document named “Domain/TopicRoot”
+-----------------------------------------------------+
<Object type=“TopicRoot”>

<Property name=“name”>Domain/TopicRoot</Property>
<Relationship name=“parent” cardinality=“0..1”>

<Reference>Domain</Reference>

</Relationship>
<Relationship name=“children” cardinality=“0..n”>

<Reference>Domain/TopicRoot/StockSymbols
</Reference>

</Relationship>

</Object>
+-----------------------------------------------------+
WebDAV document named “Domain/TopicRoot/StockSymbols”
+-----------------------------------------------------+
<Object type=“Topic”>

<Property name=“name”>Domain/TopicRoot/StockSymbols
</Property>
<Relationship name=“parent” cardinality=“0..1”>

<Reference>Domain/TopicRoot</Reference>

</Relationship>
<Relationship name=“children” cardinality=“0..n”>

<Reference>Domain/TopicRoot/StockSymbols/IBM
</Reference>
<Reference>Domain/TopicRoot/StockSymbols/HPQ
</Reference>
<Reference>Domain/TopicRoot/StockSymbols/MSFT
</Reference>

</Relationship>

</Object>
+-----------------------------------------------------+
WebDAV document named “Domain/TopicRoot/StockSymbols/IBM”
+-----------------------------------------------------+
<Object type=“Topic”>

<Property name=“name”>Domain/TopicRoot/StockSymbols/IBM
</Property>
<Relationship name=“parent” cardinality=“0..1”>

<Reference>Domain/TopicRoot/StockSymbols
</Reference>

</Relationship>
<Relationship name=“children” cardinality=“0..n”/>
</Relationship>

</Object>
+-----------------------------------------------------+
WebDAV document named “Domain/TopicRoot/StockSymbols/HPQ”
+-----------------------------------------------------+
<Object type=“Topic”>

<Property name=“name”>Domain/TopicRoot/StockSymbols/HPQ
</Property>
<Relationship name=“parent” cardinality=“0..1”>

<Reference>Domain/TopicRoot/StockSymbols
</Reference>

</Relationship>
<Relationship name=“children” cardinality=“0..n”/>
</Relationship>

</Object>
+-----------------------------------------------------+
WebDAV document named “Domain/TopicRoot/StockSymbols/MSFT”
+-----------------------------------------------------+
<Object type=“Topic”>

<Property name=“name”>Domain/TopicRoot/StockSymbols/MSFT
</Property>
<Relationship name=“parent” cardinality=“0..1”>

<Reference>Domain/TopicRoot/StockSymbols
</Reference>

</Relationship>
<Relationship name=“children” cardinality=“0..n”/>
</Relationship>

</Object>
+-----------------------------------------------------+

The XML document fragments define objects having properties and inter-relationships defined by various attributes which may be collaboratively authored in accordance with the invention. With reference to FIG. 6, the documents define a hierarchy model instance 600. Instance 600 comprises a root object “Domain” 602 in a parent/child relationship with an object “Domain/TopicRoot” 604 which in turn is in a parent/child relationship with an object “Domain/TopicRoot/Topic” 606. This object 606 is in a parent/child relationship with a topic instance, namely “Domain/TopicRoot/Topic/StockSymbols” object 608. Object 608 is in a multiple parent/child relationship with three StockSymbol instances. The three instances comprise “Domain/TopicRoot/Topic/StockSymbols/IBM”, 610 “Domain/TopicRoot/Topic/StockSymbols/HPQ” 612 and “Domain/TopicRoot/Topic/StockSymbols/MSFT 614.

Operation of system 100 will be described by way of example wherein WebDAV repository 102 stores exemplary documents defined by the above document fragments. Repository adapter 406 thus has access to all of these documents and objects via communications with WebDAV repository 102 in accordance with the WebDAV protocol. Initially, repository adapter 406 pulls the domain root object 602 from the WebDAV repository and stores it in memory 400. Collaborative authors using client computing devices 106 108 may thus communicate with server 102, invoking respective repository adapter clients 306 and repository adapter 406, to view the domain hierarchy and particular documents and objects defining the hierarchy.

As a collaborative user traverses the hierarchy, requests are sent by repository adapter client 306 to repository adapter 406, as may be required, to provide the information necessary to define the domain model to the repository adapter client. In turn, repository adapter 406 pulls the applicable documents from WebDAV repository 102 in accordance with the WebDAV protocol. Documents received by repository adapter 406 are stored in memory 400 and are provided to the requesting client in a point-to-point manner. Subsequent requests for the same document by another client, for example, may be served by repository adapter 406 from memory 400. As clients request more of the domain model, memory 400 contains a more complete copy of the domain model. Yet, each respective client stores in its respective memory 204 the domain model subset 308 it has requested.

Changes to documents, including a deletion of an existing document, object, or relation or an addition of new relationship, object or document by a repository adapter client may be understood from the following example whereby two collaborative authors using respective repository adapter clients 306 both choose to simultaneously add a new stock symbol to Object “Domain/TopicRoot/StockSymbols” 606 using system 100. Operation of system 100 is contrasted with the operation of a conventional WebDAV scenario. In the conventional scenario whereby clients operate directly with a WebDAV server and without the benefit of the present invention, one of the clients will obtain a lock on the “Domain/TopicRoot/StockSymbols” document, and the other client will attempt to lock the document in advance of making the desired change. This lock attempt will fail.

However, in accordance with the present invention, repository adapter 406 receives a change request in some arbitrary order from each of two clients 306 (i.e. a first and a second client). For example, the first client requests that a new object of type “Topic” with the name “Domain/TopicRoot/StockSymbols/APPL” be created and added to the “children” relationship of object 608 of type “Domain/TopicRoot/StockSymbols”. Further, the second client requests that a new object of type “Topic” with the name “Domain/TopicRoot/StockSymbols/PRGN” be created and added to the “children” relationship of the object 608 of the type “Domain/TopicRoot/StockSymbols”.

Whichever change request proceeds first, the final result will be the creation of the two new model objects in two new documents, and two apparently concurrent updates to the “children” relationship of the object “Domain/TopicRoot/StockSymbols” and its respective document. Proceeding in turn for each request, the processing order of which may be selected according to any suitable paradigm such as first in, first out, repository adapter 406 processes the change request in a transactional manner whereby if a step in the transaction cannot be performed, the entire transaction fails. Preferably, any steps that have been performed prior to the failure are backed out. As such, repository adapter 406 acts a controller in the MVC paradigm for serialized domain updates constructed by the GUI action of repository adapter client 306.

In the transactional manner, repository adapter 406 communicates with WebDAV repository 102 to obtain all necessary locks to the documents affected by the change request. In the present example, for the first client change request, the only existing affected document is “Domain/TopicRoot/StockSymbols”, the other document is a new one to be created. As may be necessary, the repository adapter 406 pulls a first copy of each of the affect documents from repository 102 if it does not have the document in memory 400. Further, repository adapter 406 stores in memory 400 a working copy (i.e. in addition to the first copy) of the affected documents 410. Thus in the example, a copy of “Domain/TopicRoot/StockSymbols” is stored at 410. Repository adapter 406 performs the change request actions serialized by the repository adapter client 306 against the working copies of the affected documents 410, creating any new documents as may be necessary. In the present example, the change for the first client comprises the creation of a new document “Domain/TopicRoot/StockSymbols/APPL” and its object of type Topic with the property name “Domain/TopicRoot/StockSymbols/APPL” and parent reference to object name “Domain/TopicRoot/StockSymbols”. The change request also changes the children relationship of the topic object “Domain/TopicRoot/StockSymbols” in document “Domain/TopicRoot/StockSymbols” to include a reference to the new object “Domain/TopicRoot/StockSymbols/APPL”. Following the implementation of the changes, the set of affected documents, including any new documents, are checked in to the WebDAV repository according to the WebDAV protocol. A response is sent to the requesting client to indicate the success or failure of the entire transaction. A transaction may fail, for example, if a change to a document is attempted but a prior change processed for another client prevents the change.

In addition to responding to the requesting client on the success of the performance of the request, repository adapter 406 publishes to all clients a domain update advising each of the clients of the changes made. This changes may be applied by the receiving clients to the domain model subsets 308, as may be applicable, stored in respective memories 204. As a result, each maintained domain model subset 308 at respective clients computing devices 106, 108 is updated to be consistent with the documents at server 102 and the WebDAV repository 102. In this way, clients do not need to poll (i.e. issue successive GETs) to the WebDAV repository to confirm that the client has current documents as the WebDAV repository 102, in accordance with the WebDAV protocol, does not asynchronously advise any clients of the completed actions of other clients.

Following completion of the change request, repository adapter 406 sends one or more messages to WebDAV repository 102 using the WebDAV protocol 26 to release the locks on any affected documents.

Following the processing of the first client's change request, processing of the second client's change request is undertaken in a like manner. Importantly, neither update will fail, because the granularity of the change supported is finer than a WebDAV document and the change requests can be significantly more efficient than using WebDAV directly, since a single change request can reference more than one document while WebDAV changes need to specify all the content of all the affected documents.

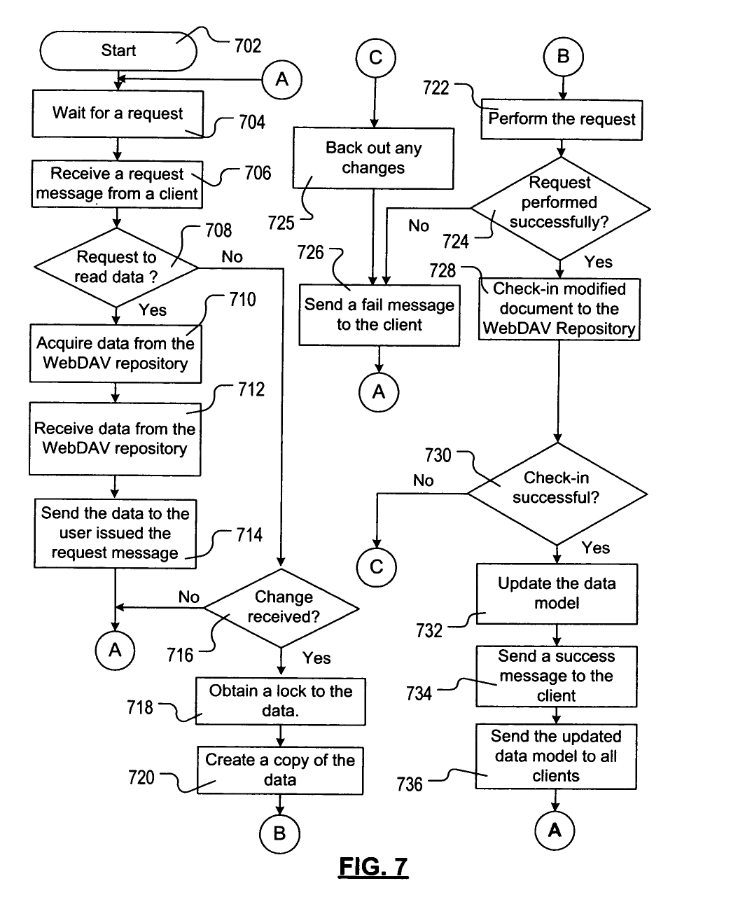

FIG. 7 is a flow chart illustrating the main operational steps involved in the processing by repository adapter 406 of request messages issued by repository adapter clients 306 with WebDAV repository 102. In an initial step 702, repository adapter 406 communicates with WebDAV repository 102 and pulls the domain object, thereafter, the repository adapter initializes maintenance of the domain model subset 408 in memory 400 and is readied for requests from collaborative authors via repository adapter clients 306 (S704) over network 120 using a bi-directional protocol 124. On receipt of a request (S706) repository adapter 406 processes the request, identifying whether the request requires that a document be obtained from repository 102 (S708). Optionally, if the document is available from memory 400, it may be provided without resort to WebDAV repository 102.

If the received request requires a document, repository adapter 406 communicates with WebDAV repository 102 (S710) to obtain the document. Following receipt of the document from WebDAV repository 102 (S712), repository adapter 406 sends the requested document to the requesting client which issued the request (step 314). Repository adapter 406 maintains its document (domain) model subset with information obtained from the received document, maintaining the model in memory at 408. Similarly clients upon receipt of the document maintain a client document model subset 308 in memory 204 from the documents it receives. It will be apparent that the document model subsets 308 at respective client computing devices 106, 108 will differ from one another depending upon the documents viewed or otherwise authored at the client devices.

If the received request is one for an action other than to obtain a document (S708), repository adapter 406 analyses the message to determine whether a change request is received (S716). If it is not a request message at all, the received message may be discarded and repository adapter 406 waits for another request (S702).

As previously noted change requests are processed in a transactional manner, whereby the particular actions necessary are serialized and undertaken and the success of the transaction as a whole is determined by the aggregate success of each action. Repository adapter 405 obtains a lock for each selected document in WebDAV repository 102 identified by the proposed change request to be affected by the proposed change (S718). A copy of the affected documents is made and stored in memory 410, as is described above with reference to FIG. 4 (step 720).

Next, repository adapter 406 performs the actions to implement the change request on the affected documents(S722). A check of whether. or not the request can be performed successfully is undertaken (S724). If the request has not been or cannot be performed successfully, repository adapter stops the transaction and backs out any performed changes, as may be necessary, (S735) and sends a failure notification message to the requesting client which issued the original request (S726).

If the request has been performed successfully, a check-in of the affected documents to WebDAV depository 102 is performed (S728). To determine whether check-in is successful, WebDAV repository 102 is polled as necessary to obtain a status result (S730). If the result is negative, repository adapter 406 may back out any successful changes (S725) and send a failure notification message to the requesting client (S726). If the check-in has been successful, repository adapter updates is own domain model subset from the working copies of the affected documents (S732), releases any locks and sends a success notification message is sent to the client which issued the original request message (S734). Additionally, repository adapter 406 publishes to all clients a domain update message to update the domain model subsets 308 stored at the client computing systems (S736). Clients receiving the update may apply the update, as applicable, to the client's documents and domain model typically stored locally during use of system 100.

Serialization of requests and transactional processing by a shared repository adapter serves to reduce resource contention otherwise experienced by collaborative authors in a conventional WebDAV environment. Fine grain changes to objects, relationships and attributes may be made using the repository adapter. Further the repository adapter asynchronously updates clients when the document model is changed, freeing the collaborative author from determining whether documents must be refreshed and obviating pre-emptive locks.

The embodiment(s) of the invention described above is(are) intended to be exemplary only. The scope of the invention is therefore intended to be limited solely by the scope of the appended claims.

I/we claim:

1. A repository adapter for facilitating the collaborative authoring by a plurality of clients of documents for storage in a repository, said repository adapter comprising:
a controller for processing and responding to client requests for authoring said documents, said processing being performed in a transactional manner; and
wherein said repository adapter adapted to communicate with said clients, to receive client requests and to send client responses to said requests; and
wherein said repository adapter adapted to communicate with said repository, to send repository requests for authoring said documents and to receive repository responses to said requests for processing said client requests.

2. The repository adapter of claim 1 wherein said documents define a document model and wherein said controller adapted to maintain a repository adapter document model subset from documents processed in accordance with said client requests.

3. The repository adapter of claim 2 wherein said controller adapted to asynchronously communicate a document model update for updating a respective client document model subset maintained by each of the plurality of clients.

4. The repository adapter of claim 2 wherein the client requests comprise serialized updates to the repository adapter document model to affect changes to selected documents for storage to the repository.

5. The repository adapter of claim 4 wherein said controller adapted to lock said selected documents stored in said repository.

6. The repository adapter of claim 4 wherein said controller adapted to process said serialized updates using a working copy of said selected documents in response to a success of the lock of said selected documents.

7. The repository adapter of claim 6 wherein said controller adapted to store to said repository said selected documents following the success of the processing of said serialized updates.

8. The repository adapter of claim 7 wherein said controller adapted to communicate to the client having sent the serialized updates a client response indicative of. a success of the client request, said success defined by the success of the locking, processing and storing of the affected selected documents.

9. The repository adapter of claim 1 wherein said controller adapted to communicate to the client having sent the serialized update a client response indicative of a success of the client request.

10. The repository adapter of claim 1 wherein said controller, responsive to a client request for a document stored in said repository, sends said requested document having requested the document from the repository.

11. The repository adapter of any one of claims 1 to 10 wherein the repository is a WebDAV repository.

12. A repository adapter client for facilitating the collaborative authoring by a plurality of clients of documents for storage in a repository, said repository adapter client comprising:
a controller for creating client requests for authoring said documents;
wherein said repository adapter client adapted to communicate said client requests to a repository adapter for processing said client requests in a transactional manner and, selectively, in communication with said repository and to receive client responses to said requests.

13. The repository adapter client of claim 11 wherein said documents define a document model and wherein said controller adapted to maintain a client document model subset from documents processed in accordance with said client requests.

14. The repository adapter client of claim 12 wherein said controller adapted to asynchronously receive a document model update identifying changes for updating the client document model subset.

15. The repository adapter client of claim 12 wherein the client requests each comprise serialized updates to the client document model to affect changes to selected documents for storage to the repository.

16. The repository adapter client of any one of claims 12 to 15 wherein the repository adapter client adapts an integrated development environment (IDE) for collaboratively authoring said documents in communication with said repository adapter.

17. The repository adapter client of any one of claims 12 to 16 wherein the repository is a WebDAV repository.

18. A method for collaboratively authoring documents for storage to a document repository comprising steps of:
maintaining a document model subset defined by at least a subset of the documents stored to the repository;
receiving from a client a client request for collaboratively authoring said documents;
processing the client request in a transactional manner and, selectively, in communication with the repository; and
sending a notification message to the client in response to a success of the processing of the client request.

19. The method of claim 18 comprising sending asynchronously a document model update message to each of a plurality of clients for updating a client document model subset respectively maintained by said clients upon a successful processing of the client request.

20. The method of claim 18 wherein the step of processing the client request further comprises steps of:
analysing the client request in order to identify the need to obtain a document from the repository;
acquiring the document specified by the client request from the repository; and
sending the requested document to the client.

21. The method of claim 18 wherein the client request comprises serialized updates to the document model subset to affect changes to selected documents for storage to the repository.

22. The method of claim 18 wherein the step of processing comprises storing to said repository said selected documents to which the updates are affected only if all of said updates are affected successfully.

23. The method of claim 18 including the step of locking said selected documents in said repository until the success of all updates to the selected documents can be determined.

24. A method for collaboratively authoring documents for storage to a document repository comprising steps of:
maintaining a document model subset defined by at least a subset of the documents stored to the repository;
sending to a repository adapter a client request for collaboratively authoring said documents, said repository adapter adapted for processing the request message in a transactional manner and, selectively, in communication with the repository; and
receiving a notification message from the repository adapter in response to a success of the processing of the client request.

25. The method of claim 24 wherein the repository adapter is configured to send asynchronously a document model update message to each of a plurality of clients for updating a client document model subset respectively maintained by said clients, said update being sent in response to a success of the processing of a client request.

26. The method of claim 18 wherein the client request comprises serialized updates to a document model subset maintained by the repository adapter to affect changes to selected documents for storage to the repository.

27. An integrated development environment (IDE) for collaboratively authoring documents for storage to a repository comprising:
a graphical user interface for facilitating the authoring of a document model subset defined by at least a subset of documents stored to said repository;
a mechanism for serializing updates to the document model subset in response to said authoring; and
a communications interface to send client requests comprising said serialized updates to a repository adapter adapted for processing client request messages in a transactional manner and, selectively, in communication with the repository.

28. The IDE of claim 27 wherein the communication interface is adapted to receive asynchronously a document model update message for updating the document model subset by the IDE.

29. The IDE of claim 28 wherein said update message is sent by said repository adapter to each of a plurality of clients in response to a success of the processing of a client request that updates a document for storing to the repository.

30. A method of adapting a WebDAV repository to asynchronously notify a plurality of clients of a change to at least one document stored to the WebDAV repository comprising:
maintaining a document model subset defined by at least a subset of documents stored to the WebDAV repository;
receiving from a client a client request for collaboratively authoring at least one of said documents;
processing the client request in communication with the WebDAV repository; and
sending asynchronously a document model update message to the plurality of clients to notify the clients of the change to the at least one of said documents.

31. The method of claim 30 wherein the step of processing is adapted to process the client request in a transactional manner.
